(19) United States
(12) Patent Application Publication
(10) Pub. No.: US 2022/0074246 A1
(43) Pub. Date: Mar. 10, 2022

(54) Adapter Bracket for a Garage Door Brace

(71) Applicant: Storm Supply Depot, LLC, Pompano Beach, FL (US)

(72) Inventor: Michael Wittlin, Boca Raton, FL (US)

(21) Appl. No.: 17/445,005

(22) Filed: Aug. 13, 2021

Related U.S. Application Data
(60) Provisional application No. 63/074,517, filed on Sep. 4, 2020.

(51) Int. Cl. E05C 19/00

(52) U.S. Cl. CPC E05C 19/003

(57) ABSTRACT

An adapter bracket for attaching a vertical garage door brace to a garage door has a base plate with an upper tab and a lower tab. A left and right side wing stick out from the sides of the base plate. The side wings bend forward to form left and right forward tabs. The tabs each have a 0.38 inch diameter hole in them to receive a standard size mounting bolt. The bolt is the same size bolt used to attach the garage door brace to hollow door hinges. If the hinges are not hollow, then the hinges are removed when a strong wind is anticipated. The adapter brackets then replace the hinges so that the standard bolt can be used to attach the brace to the door.

### FIELD OF INVENTION

The inventions described herein are in the field of wind bracing for garage doors.

### BACKGROUND

FIG. 1A is a side view of a prior art garage door brace 31 for reinforcing a multi-panel garage door 10 against strong winds. Said figure is based on FIG. 4 of U.S. Pat. No. 6,082,431, “System of Telescoping Longitudinally Grooved Door-Stiffening Columns for Bracing Garage Door Against Hurricane Force Winds” (Decola). Said patent is incorporated herein by reference with specific reference to the definitions of the item numbers presented therein. Not all of said item numbers are discussed herein.

The garage door is a multi-panel overhead door. Each panel 11 is held to an adjacent panel by a hollow hinge 13. When high winds are expected, the brace 31 is set up and attached to the garage door by one or more deflection brackets 54. Said deflection brackets are joined to the hollow hinges 13 by bolts 61 that pass therethrough. The door cannot be opened once the brace it installed. When the high winds have passed, the bolts are removed and the brace is stored away for future use. The garage door can then be used.

FIG. 1B is a top cross-sectional view of brace 31 attached via deflection brackets 55, 56 to a hollow hinge 13. The horizontal spacing 101 between the deflection brackets is typically about 3 inches. This allows the brackets to span the width of the hollow hinge with suitable clearance. A hole 60 is provided in the distal end of each deflection bracket to accommodate the bolt 61 that will pass through the hollow tubing 63 of the hollow hinge 13. In the United States, the hollow tubing typically has an internal diameter of about 0.38 inches. A suitable diameter for the bolt, therefore is about 0.31 inches. This allows the bolt to pass through the tube without allowing too much play if the door vibrates during high wind. A suitable diameter for the holes 60 at the distal end of the deflection brackets is also about 0.38 inches.

Whereas hinges with hollow tubing are common for multi-panel garage doors, they are not universal. Many modern door designs use hinges with different configurations. There is need, therefore, for an adapter bracket that can allow the deflection brackets designed for hollow hinges to be used on a wider variety of garage doors.

### SUMMARY OF INVENTION

The summary of the invention is a guide to understanding the invention. It does not necessarily describe the most generic embodiment.

FIG. 2 is a top left orthographic view of a strap hinge 200 joining adjacent panels 202, 204 on a multi-panel garage door. The hinge comprises an upper leaf 212 joined to a lower leaf 214 by a joint 218. The joint is not hollow. The upper and lower leaf are each attached to corresponding vertical stiles 206, 207 using bolts 216. The horizontal edges of the cores 210, 211 of the panels are reinforced by edge struts 208, 209. This is an example of a hinge that would not be compatible with the prior art deflection brackets.

FIG. 3 is a top left orthographic view of a one-piece adapter bracket 300. The adapter bracket will temporarily replace the strap hinge 200 when high winds are expected to provide a fitting that will be compatible with the prior art deflection brackets. The adapter bracket comprises:
a) a base plate 342 comprising:
   i. an upper tab 302; and
   ii. a lower tab 304;
b) a left side wing 306 proceeding laterally from a left side 334 of said base plate;
c) a right side wing 308 proceeding laterally from a right side 332 of said base plate;
d) a left forward tab 322 proceeding forward from a left side 338 of said left side wing; and
e) a right forward tab 324 proceeding forward from a right side 336 of said right side wing
   wherein:
f) said upper tab comprises an elongated upper slot 312 centered about a vertical centerline 311 of said base plate;
g) said lower tab comprises an elongated lower slot 314 centered about said vertical centerline of said base plate;
h) said left forward tab comprises a left bolt hole 326;
i) said right forward tab comprises a right bolt hole 328 horizontally aligned 321 with said left bolt hole; and
j) said left bolt hole and said right bolt hole each have a diameter of about 0.38 inches in order to be compatible with deflection brackets sized for standard US hollow hinges.

A suitable overall length 301 of the base plate may be about 10 inches. A suitable width 303 of the base plate may be about 1.5 inches. Other dimensions may be provided for different garage door configurations. The upper slot and lower slot may each have a length 315 of about 3.5 inches, a width 313 of about 0.38 inches and a vertical spacing therebetween 317 of about 1.63 inches. These dimensions will accommodate most hinge configurations. Other dimensions, such as a narrower slot width, may be suitable. Washers may be provided when the heads of the bolts 216 of the hinges are smaller than the slot widths.

The horizontal spacing 325 between the left forward tab and right forward tab may be about 3 inches. This will be compatible with the spacing of the deflection brackets of most braces. Wider or narrower spacing may be provided depending upon the particular spacing of deflection brackets in a given brace.

The left forward tab and right forward tab may each have a height 323 of about 1.5 inches and a forward extension 327 from said base plate of about 1.5 inches. The center of each of said left bolt hole and right bolt hole may have a forward extension 329 from said base plate of about 0.75 inches. These dimensions are compatible with existing common deflection brackets. Other dimensions may be provided for differently dimensioned brackets.

The materials of construction of the adapter bracket may comprise one or more of metal, plastic or carbon fiber composite of sufficient strength such that if a bolt with a diameter of about 0.31 inches is placed through said bolt holes and pulled with a force of 1500 pounds while said base plate is attached to a garage door, said adapter bracket will not mechanically fail. A thickness 305 of about 0.06 inches is suitable for adapter brackets made from steel sheet.

In the United States, a bolt with a diameter of about 0.31 inches is standard for defection brackets used with hinges with hollow tubes. In other regions, different bolt sizes may be standard. 1500 pounds of force is the force that may be exerted on an adapter bracket due to a 200 mph winds acting on a large commercial multi-panel garage door. Smaller residential garage doors with more hinges per square foot of garage door area may only experience 600 lbs per adapter bracket. Adapter brackets for residential use may therefore, be lighter weight than for commercial installations.

The adapter bracket may be a unitary piece made from a single sheet of material.

Adapter brackets may be provided with replacement deflection brackets. The adapter brackets and/or deflection brackets may be made from light weight, high strength materials, such as carbon fiber composites. Carbon fiber designs may be provided with ribs for additional stiffening. This will reduce the amplitude of vibration of a garage door due to wind turbulence.

FIG. 4 is a top left orthographic view of the one-piece adapter bracket 300 of FIG. 3 joining the adjacent panels 202, 204 of the multi-panel garage door of FIG. 2 after the strap hinge 200 has been removed in preparation for high wind. Hinge functionality is not needed at this time since it will not be possible to open the door due to the brace 31 (not shown). The same bolts 216 that held the strap hinge to the vertical stiles 206, 207 of the adjacent panels are now used to hold the base plate to the panels by passing through the slots 312, 314. The bolt holes 326 and 328 are now available to attach to the deflection brackets 55, 56 (not shown) using a standard size bolt 61 (not shown). When the high wind period is over, the adapter brackets can be removed and replaced with the original strap hinges.

Not all strap hinges need to be replaced when high winds are expected. High strength adapter brackets, for example may be provided that only need to replace a portion of the strap hinges. This will make set up faster.

### BRIEF DESCRIPTION OF DRAWINGS

FIG. 1A is a side view of a prior art garage door brace installed on a multi-panel garage door.

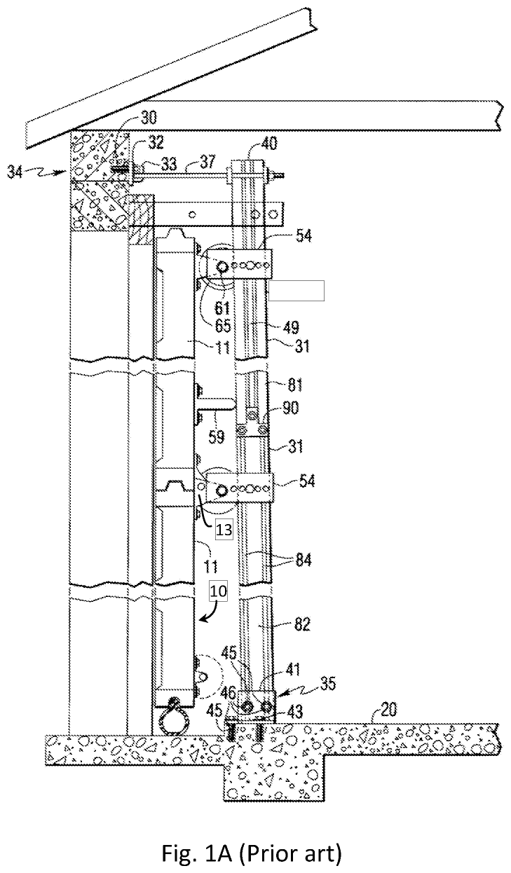

FIG. 1B is a top cross sectional view of the garage door brace of FIG. 1A showing the brace attached to a hollow tube hinge on the garage door by a pair of deflection brackets.

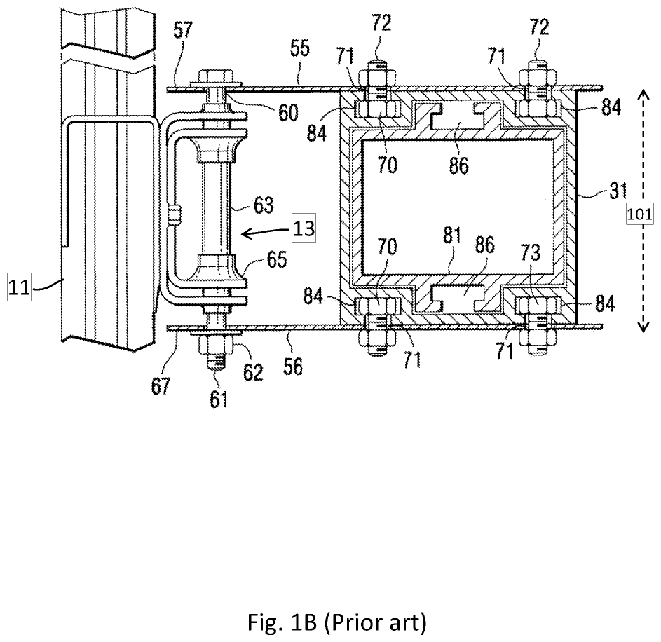

FIG. 2 is a top left orthographic view of a strap hinge joining adjacent panels on a multi-panel garage door.

FIG. 3 is a top left orthographic view of a one-piece adapter bracket.

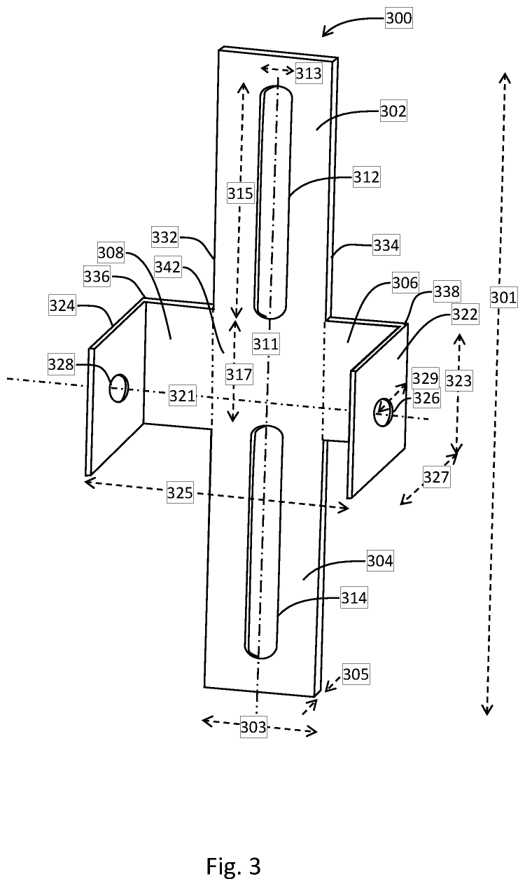

FIG. 4 is a top left orthographic view of the one-piece adapter bracket of FIG. 3 joining adjacent panels on a multi-panel garage door.

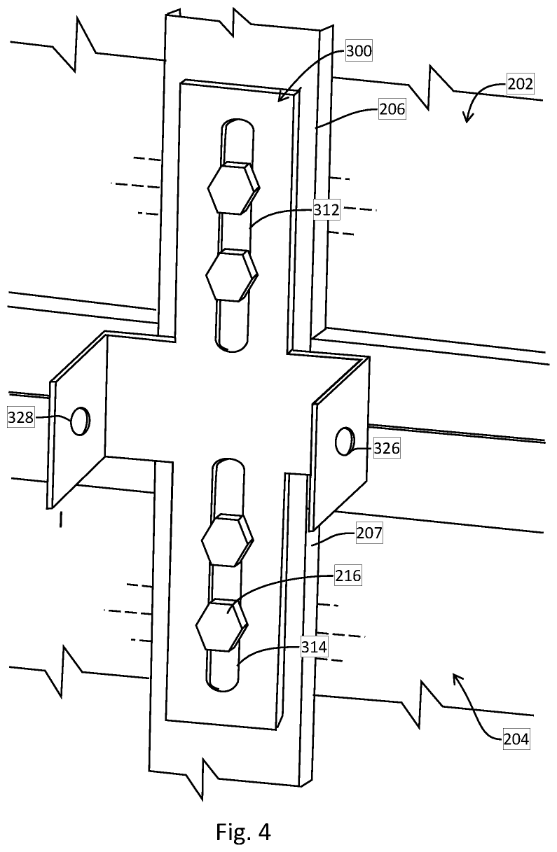

FIG. 5 is a top left orthographic exploded view of a multi-piece adapter bracket.

FIG. 6 is a top left orthographic view of an assembled multi-piece adapter bracket of FIG. 5 joining adjacent panels on a multi-panel garage door.

FIG. 7 is a top left orthographic view of a wing bracket installed on a horizontal wind strut mounted at a mid-level of a panel of a multi-panel garage door.

### DETAILED DESCRIPTION

The detailed description describes non-limiting exemplary embodiments. Any individual features may be combined with other features as required by different applications for at least the benefits described herein. As used herein, the term “about” means plus or minus 10% of a given value unless specifically indicated otherwise.

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

As used herein, the term “shaped” means that an item has the overall appearance of a given shape even if there are minor variations from the pure form of said given shape.

As used herein, the term “generally” when referring to a shape means that an ordinary observer will perceive that an object has said shape even if there are minor variations from said shape.

As used herein, relative orientation terms, such as “up”, “down”, “top”, “bottom”, “left”, “right”, “vertical”, “horizontal”, “distal” and “proximal” are defined with respect to an initial presentation of an object and will continue to refer to the same portion of an object even if the object is subsequently presented with an alternative orientation, unless otherwise noted.

As used herein the terms “left” and “right” generally refer to left and right from an object's perspective unless indicated otherwise.

### Multi-Piece Adapter Bracket

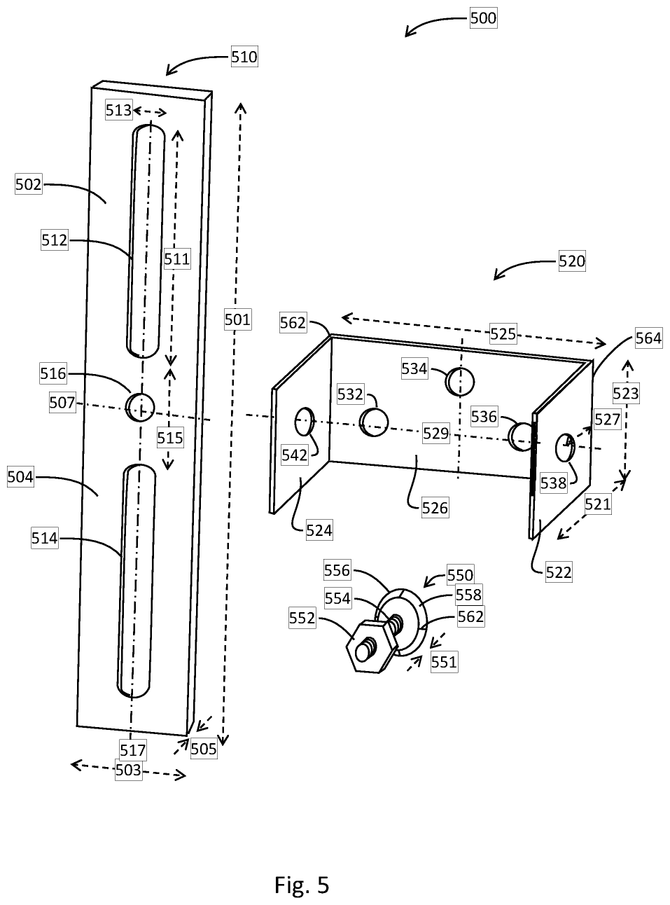

FIG. 5 is a top left orthographic exploded view of a multi-piece adapter bracket 500. The adapter bracket comprises:
a) a base plate 510 comprising:
   i) an upper tab 502; and
   ii) a lower tab 504;
b) a wing bracket 520 comprising:
   i) a back plate 526;
   ii) a left forward tab 522 proceeding forward from a left side 564 of said back plate; and
   iii) a right forward tab 524 proceeding forward from a right side 562 of said back plate; and
c) a 550 fastener for joining said wing bracket to said base plate
   wherein:
d) said upper tab comprises an elongated upper slot 512 centered about a vertical centerline 517 of said base plate;
e) said lower tab comprises an elongated lower slot 514 centered about said vertical centerline of said base plate;
f) said left forward tab comprises a left bolt hole 538;
g) said right forward tab comprises a right bolt hole 542 horizontally aligned 529 with said left bolt hole; and
h) said left bolt hole and said right bolt hole each have a diameter of about 0.38 inches.

The base plate may comprise a mounting hole 516 located between said upper and lower slots. The mounting hold may be centered on a horizontal centerline 507 of said base plate.

The back plate of the wing bracket may comprise a first 532, second 534 and third 536 mounting holes arranged in an equilateral triangle. When the wing bracket is attached to the base plate, the fastener proceeds through said mounting hole of said base plate and one of said first, second or third mounting holes of said back plate.

Any fastener may be used, such as a nut and bolt. Fasteners, such as tabs, snaps and/or slots, may be built into the base plate and wing bracket. Permanent fasteners such as rivets or industrial adhesives may be used.

The arrangement of mounting holes allows the wing bracket to be mounted in a variety of configurations relative to the base plate. This will improve the adaptability of the adapter bracket to a variety of garage door configurations.

The fastener may comprise a nut 552 and a bolt 554. The bolt may comprise a head 556. The head may be adapted to fit into the mounting hole of the base plate such that the head does not protrude from a back surface of said base plate. The mounting hole, for example, may be a tapered hole. The head of the bolt may have a corresponding flare 558. The head of the bolt may further comprise a locking mechanism, such as one or more radial ridges 562, such that the head will rotationally lock into place when the bolt is placed through the mounting hole. Thus, when the wing bracket is placed over the bolt and the nut is screwed thereupon and tightened, the blot will not rotate.

The base plate may have a length 501 of about 10 inches. The base plate may have a width 503 of about 1.5 inches. The upper slot and the lower slot each may have a length 511 of about 3.5 inches. The upper slot and lower slot may each have a width 513 of about 0.38 inches. The upper and lower slot may have a vertical spacing 515 therebetween of about 1.63 inches. These collective dimensions help ensure that the base plate can be mounted on a broad selection of stiles with different hinge mounting configurations. Different dimensions can be alternatively provided for different garage door configurations.

The horizontal spacing 525 between the left forward tab and right forward tab of the wing bracket may be about 3 inches. Each of said left forward tab and said right forward tab may have a height 523 of about 1.5 inches and a forward extension 521 from said back plate of about 1.5 inches. A center of each of said left bolt hole and right bolt hole may have a forward extension 527 from the back plate of about 0.75 inches. These collective dimensions help ensure that the wing bracket will effectively simulate a standard hollow hinge such that typical deflection brackets sized for said hollow hinges may be joined to said wing bracket using a bolt sized for said hollow hinges (e.g. 0.31 inch diameter bolt).

Similar to the one piece adapter bracket, the material of construction for the multi-piece adapter bracket may comprise one or more of metal, plastic or carbon fiber composite of sufficient strength such that if a bolt with a diameter of about 0.31 inches is placed through said bolt holes and pulled with a force of 1500 pounds while said base plate is attached to a garage door, said adapter bracket will not mechanically fail.

A thickness 505 of about 0.06 inches is suitable for adapter brackets made from steel sheet. A similar thickness 551 is suitable for the head of the bolt of the fastener such that the head will not protrude from either a front surface of the base plate or the back surface of the base plate.

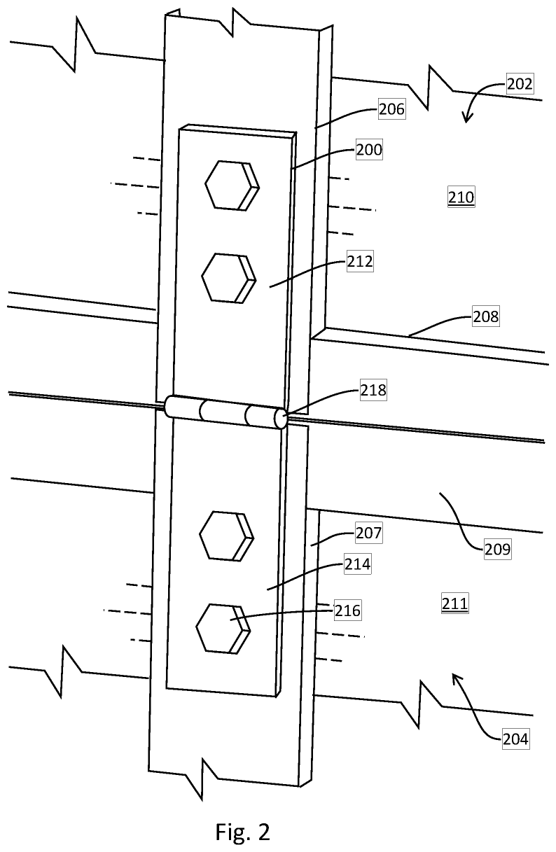

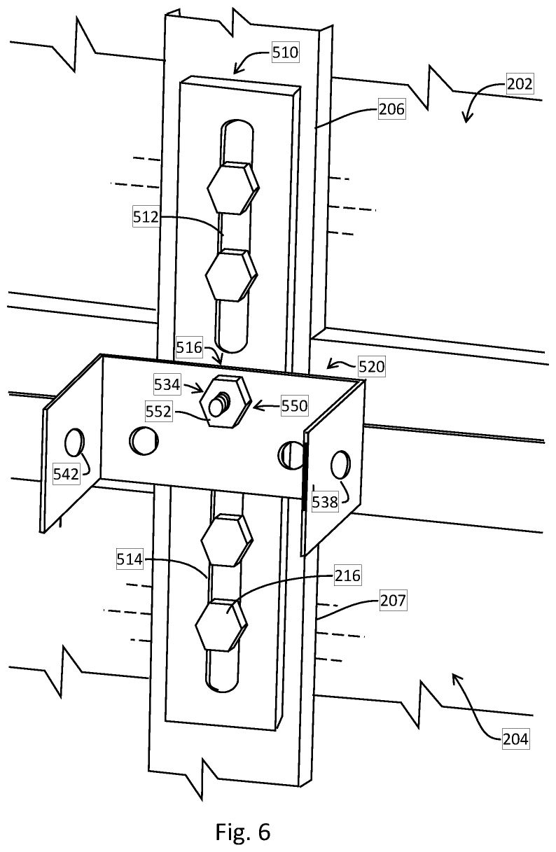

FIG. 6 is a top left orthographic view of an assembled multi-piece adapter bracket 500 of FIG. 5 joining the adjacent panels 202, 204 of the multi-panel garage door of FIG. 2 after the strap hinge 200 has been removed in preparation for high wind. Hinge functionality is not needed at this time since it will not be possible to open the door due to the brace 31 (not shown). The same bolts 216 that held the strap hinge to the vertical stiles 206, 207 of the adjacent panels are now used to hold the base plate to the panels by passing through the slots 512, 514. The bolt holes 538 and 542 are now available to attach to the deflection brackets 55, 56 (not shown) using a standard size bolt 61 (not shown). When the high wind period is over, the adapter brackets can be removed and replaced with the original strap hinges.

Not all strap hinges need to be replaced. High strength adapter brackets, for example may be provided that only need to replace a portion of the strap hinges. This will make set up faster.

### System for Bracing a Garage Door

An adapter bracket can be provided with a vertical brace and deflection brackets to provide a complete system for garage door bracing against strong winds. The system may comprise:
a) a vertical brace 31;
b) two horizontal deflection brackets 55, 56 attached to said vertical brace, each horizontal deflection bracket comprising a hole at its distal end, said hole having a diameter of about 0.38 inches;
c) a bolt 60 having a diameter of about 0.31 inches;
d) an adapter bracket 500 comprising:
   i) a base plate 510 comprising:
      1) an upper tab 502; and
      2) a lower tab 504;
   ii) a wing bracket 520 comprising:
      1) a back plate 526;
      2) a left forward tab 522 proceeding forward from a left side 564 of said back plate; and
      3) a right forward tab 524 proceeding forward from a right side 562 of said back plate; and
         iii) a fastener 550 joining said wing bracket to said base plate
         wherein:
e) said upper tab 502 comprises an elongated upper slot 512 centered about a vertical centerline 517 of said base plate;
f) said lower tab 504 comprises an elongated lower slot 514 centered about said vertical centerline of said base plate;
g) said left forward tab comprises a left bolt hole 538;
h) said right forward tab comprises a right bolt hole 542 horizontally aligned 529 with said left bolt hole;
i) said left bolt hole and said right bolt hole each have a diameter of about 0.38 inches; and
j) said bolt holes are aligned with said holes in said deflection brackets such when said base plate is attached to said garage door, said base plate may be reversibly attached to said deflection brackets by passing said bolt therethrough.

Any vertical brace of adequate strength may be used. Any deflection tabs of adequate strength may be used. A one-piece adapter bracket 300 may be used. An advantage of the multi-piece adapter bracket 500 is that for some garage door designs, the wing bracket 520 can be mounted on alternative locations of the door panels 202, 204 such that the existing strap hinges remain in place.

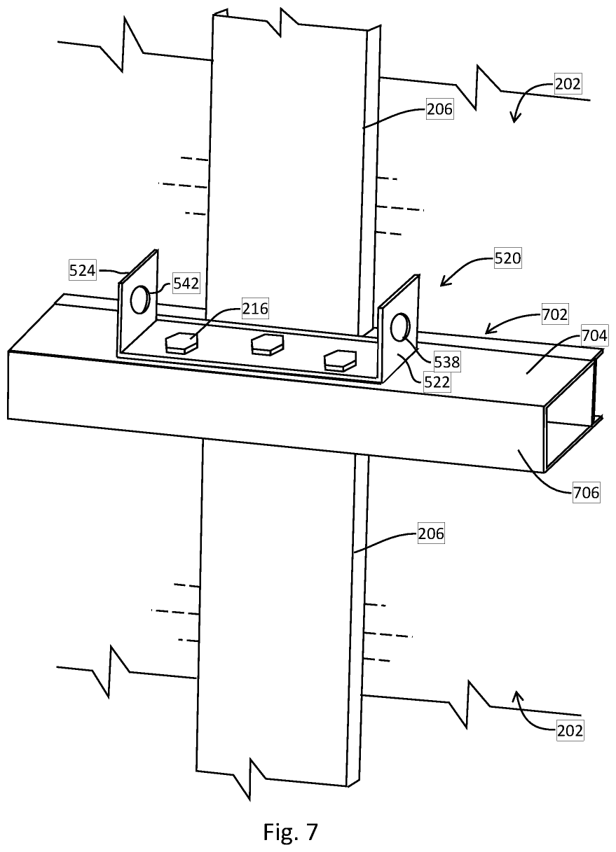

FIG. 7 is a top left orthographic view of a wing bracket 520 installed on a horizontal wind strut 702 mounted at a mid-level of a panel 202 of a multi-panel garage door. The wing bracket is shown mounted using bolts 216. Any mounting means, including permanent mounting means, however, may be used. For example, the wing bracket may be mounted using an industrial adhesive with adequate peel strength such that the wing bracket will remain attached when subject to a 1500 lb static force. The industrial adhesive should also be rated for adequate fatigue resistance such that it can withstand vibrations of the door due to a strong wind.

The left forward tab 522 and right forward tab 524 are shown pointing up. The left and right bolt holes 538, 542 are available to receive the bolt 61 (not shown) from the deflection brackets 55, 56 (not shown).

The system, therefore, can be adapted to most any multi-panel garage design. Thus, all users can achieve greater protection against high wind damage to their garage doors.

### CONCLUSION

While the disclosure has been described with reference to one or more different exemplary embodiments, it will be understood by those skilled in the art that various changes may be made and equivalents may be substituted for elements thereof without departing from the scope of the disclosure. In addition, many modifications may be made to adapt to a particular situation without departing from the essential scope or teachings thereof. For example, the “adaptability” of the adapter bracket allows it to provide a solution for virtually any garage door regardless of existing horizontal braces or obstacles. This includes, but it not limited to: barrel hinges that are too under sized to accommodate the through bolt; non-barrel hinges; or really any kind of hinge. The wing bracket can also be attached directly to the garage door without touching the existing hinges (e.g. by drilling a ⅜″ hole thru the door and using a flat head bolt with the flat head outside the door and connecting the adapter on the inside of the door). Therefore, it is intended that the disclosure not be limited to the particular embodiment disclosed as the best mode contemplated for carrying out this invention.

I claim:

1. An adapter bracket for a garage door brace, said adapter bracket comprising:
a) a base plate comprising:
i) an upper tab; and
ii) a lower tab;
b) a left side wing proceeding laterally from a left side of said base plate;
c) a right side wing proceeding laterally from a right side of said base plate;
d) a left forward tab proceeding forward from a left side of said left side wing; and
e) a right forward tab proceeding forward from a right side of said right side wing
wherein:
f) said upper tab comprises an elongated upper slot centered about a vertical centerline of said base plate;
g) said lower tab comprises an elongated lower slot centered about said vertical centerline of said base plate;
h) said left forward tab comprises a left bolt hole; and
i) said right forward tab comprises a right bolt hole horizontally aligned with said left bolt hole.

2. The adapter bracket of claim 1 wherein:
a) said base plate has a length of about 10 inches;
b) said base plate has a width of about 1.5 inches;
c) said upper slot and said lower slot each have a length of about 3.5 inches;
d) said upper slot and said lower slot each have a width of about 0.38 inches;
e) said upper and lower slot have a vertical spacing therebetween of about 1.63 inches; and
f) said left bolt hole and said right bolt hole each have a diameter of about 0.38 inches.

3. The adapter bracket of claim 1 wherein a horizontal spacing between said left forward tab and said right forward tab is about 3 inches.

4. The adapter bracket of claim 1 wherein each of said left forward tab and said right forward tab have a height of about 1.5 inches and a forward extension from said base plate of about 1.5 inches.

5. The adapter bracket of claim 4 wherein a center of each of said left bolt hole and right bolt hole has a forward extension from said base plate of about 0.75 inches.

6. The adapter bracket of claim 1 wherein a material of construction of said adapter bracket comprises one or more of metal, plastic or carbon fiber composite of sufficient strength such that if a bolt with a diameter of about 0.31 inches is placed through said bolt holes and pulled with a force of 1500 pounds while said base plate is attached to a garage door, said adapter bracket will not mechanically fail.

7. The adapter bracket of claim 1 wherein said adapter bracket is a unitary piece made from a single sheet of material.

8. An adapter bracket for a garage door brace, said adapter bracket comprising:
a) a base plate comprising:
i) an upper tab; and
ii) a lower tab;
b) a wing bracket comprising:
i) a back plate;
ii) a left forward tab proceeding forward from a left side of said back plate; and
iii) a right forward tab proceeding forward from a right side of said back plate; and
c) a fastener joining said wing bracket to said base plate
wherein:
d) said upper tab comprises an elongated upper slot centered about a vertical centerline of said base plate;
e) said lower tab comprises an elongated lower slot centered about said vertical centerline of said base plate;
f) said left forward tab comprises a left bolt hole; and
g) said right forward tab comprises a right bolt hole horizontally aligned with said left bolt hole.

9. The adapter bracket of claim 8 wherein:
a) said base plate comprises a mounting hole located between said upper and lower slots
b) said back plate comprises first, second and third mounting holes arranged in an equilateral triangle; and
c) said fastener proceeds through said mounting hole of said base plate and one of said first, second or third mounting holes of said back plate.

10. The adapter bracket of claim 9 wherein said fastener comprises a head adapted to fit into said mounting hole of said base plate such that said head does not protrude from a back surface of said base plate.

11. The adapter bracket of claim 8 wherein:
a) said base plate has a length of about 10 inches;
b) said base plate has a width of about 1.5 inches;
c) said upper slot and said lower slot each have a length of about 3.5 inches;
d) said upper slot and said lower slot each have a width of about 0.38 inches;
e) said upper and lower slot have a vertical spacing therebetween of about 1.63 inches; and
f) said left bolt hole and said right bolt hole each have a diameter of about 0.38 inches.

12. The adapter bracket of claim 8 wherein a horizontal spacing between said left forward tab and said right forward tab is about 3 inches.

13. The adapter bracket of claim 8 wherein each of said left forward tab and said right forward tab have a height of about 1.5 inches and a forward extension from said back plate of about 1.5 inches.

14. The adapter bracket of claim 13 wherein a center of each of said left bolt hole and right bolt hole has a forward extension from said back plate of about 0.75 inches.

15. The adapter bracket of claim 8 wherein a material of construction of said adapter bracket comprises one or more of metal, plastic or carbon fiber composite of sufficient strength such that if a bolt with a diameter of about 0.31 inches is placed through said bolt holes and pulled with a force of 1500 pounds while said base plate is attached to a garage door, said adapter bracket will not mechanically fail.

16. The adapter bracket of claim 8 wherein each of said base plate and wing bracket is a unitary piece made from a single sheet of material.

17. A system for bracing a garage door against strong winds, said system comprising:
a) a vertical brace;
b) two horizontal deflection brackets attached to said vertical brace, each horizontal deflection bracket comprising a hole at its distal end, said hole having a diameter;
c) a bolt having a diameter less than said diameter of said holes in said distal ends of said deflection brackets;
d) an adapter bracket comprising:
i) a base plate comprising:
1) an upper tab; and
2) a lower tab;
ii) a wing bracket comprising:
1) a back plate;
2) a left forward tab proceeding forward from a left side of said back plate; and
3) a right forward tab proceeding forward from a right side of said back plate; and
iii) a fastener joining said wing bracket to said base plate
wherein:
e) said upper tab comprises an elongated upper slot centered about a vertical centerline of said base plate;
f) said lower tab comprises an elongated lower slot centered about said vertical centerline of said base plate;
g) said left forward tab comprises a left bolt hole;
h) said right forward tab comprises a right bolt hole horizontally aligned with said left bolt hole;
i) said left bolt hole and said right bolt hole each have a diameter greater than said diameter of said bolt; and
j) said bolt holes are aligned with said holes in said deflection brackets such when said base plate is attached to said garage door, said base plate may be reversibly attached to said deflection brackets by passing said bolt therethrough.

18. The system of claim 17 wherein:
a) said diameter of said bolt is about 0.31 inches: and
b) said diameters of said left bolt hole and said right bolt hole are each about 0.38 inches.
